(19) United States
(12) Patent Application Publication
(10) Pub. No.: US 2015/0143262 A1
(43) Pub. Date: May 21, 2015

(54) SYSTEM AND METHOD FOR VIEWERS TO COMMENT ON TELEVISION PROGRAMS FOR DISPLAY ON REMOTE WEBSITES USING MOBILE APPLICATIONS

(71) Applicant: SOCIAL COMMENTING, LLC, Sedona, AZ (US)

(72) Inventors: Michael Roy Norwood, Phoenix, AZ (US); Stephen Malvern Omohundro, Palo Alto, CA (US)

(73) Assignee: SOCIAL COMMENTING, LLC, Sedona, AZ (US)

(21) Appl. No.: 14/548,582

(22) Filed: Nov. 20, 2014

Related U.S. Application Data
(63) Continuation-in-part of application No. 13/759,693, filed on Feb. 5, 2013.
Application No. 13/759,693 is a continuation of application No. 11/818,912, filed on Jun. 15, 2007, now Pat. No. 8,402,357.
(60) Provisional application No. 61/906,412, filed on Nov. 20, 2013.
(60) Provisional application No. 60/813,982, filed on Jun. 15, 2006.

(51) Int. Cl. H04L 29/08; H04L 12/58; H04N 21/4782; G06F 3/0484; H04N 21/4788; H04N 21/475

(52) U.S. Cl. CPC H04L 67/02; H04N 21/4788; H04N 21/4756; H04N 21/4782; G06F 3/0484; H04L 51/16; H04L 51/32; H04L 51/10; H04L 51/046
USPC 715/753

(57) ABSTRACT

A software system, method, application that allows television and cinema viewers to create, store, and display on remote websites comments pertaining to viewed content (e.g. programs, streaming movies, advertisements). The viewer utilizes an electronic computing device (e.g. smartphone, television with Internet connectivity, etc.) and comprising an application (e.g. mobile app, IVT app) to enter comments and transmit them to a third party database for storage and/or display on website(s) (e.g. social media). The applications display user interface elements allowing the viewer to identify the television content (i.e. title of show), and to receive comment data input, which is then transmitted to remote second servers for storage, and/or for display by the second servers on websites, and/or viewing in applications by other users, who may respond to the comments. The data from a plurality of end-user's comments may be statistically analyzed before distribution to third parties, such as marketing firms.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the priority under 35 U.S.C. §119(e) to the provisional application for patent filed in the United States on Nov. 20, 2013, bearing the title of “SYSTEM AND METHOD FOR VIEWERS TO COMMENT ON TELEVISION PROGRAMS FOR DISPLAY ON REMOTE WEBSITES USING MOBILE APP'S”, and assigned application Ser. No. 61/906,412.

Further, this application is a continuation-in-part of U.S. patent application Ser. No. 13/759,693, filed on Feb. 5, 2013, which application is a continuation of U.S. patent application Ser. No. 11/818,912 filed on Jun. 15, 2007 and issued as U.S. Pat. No. 8,402,357 to Norwood et al., on Mar. 19, 2013, and bears the title of “SYSTEM AND METHOD FOR FACILITATING POSTING OF PUBLIC AND PRIVATE USERS COMMENTS AT A WEB SITE”, which application is a non-provisional application of United States Provisional application for patent filed on Jun. 15, 2006 and assigned Ser. No. 60/813,982

Each of these above-referenced applications is hereby incorporated by reference in its entirety.

### BACKGROUND

The present disclosure relates generally to Internet methods for viewers to comment on television and cinema content using their electronic computing devices utilizing a mobile app.

Television has been an important source of news and entertainment since its commercial introduction in 1928. For decades, television watching has been a passive experience. Initially viewers could only watch what was being broadcast at the moment. These characteristics made television an ideal advertising medium and the revenue from television ads has supported the creation of programming since its inception. The introduction of video tape allowed viewers to “time-shift” programs and watch programs when they chose. It also allowed viewers to skip over commercials. The introduction of cable networks dramatically increased the quantity and variety of programming. But it also had the effect of spreading a fixed number of viewers over many more shows, lowering the advertising value of each show.

### SUMMARY

The various embodiments disclosed herein serve to make the television viewing experience into an active rather than a passive one and it engages viewers with content in a way that increases the value of advertising. Today, younger viewers especially do not passively watch television shows. They talk on the phone, text, or email their friends about what it happening as it happens. This creates deeper social connections and turns the viewing experience into something more active and creative. So-called “second screens” provide an active channel for deeper engagement with programming.

Michael Norwood's U.S. Pat. No. 8,402,357 introduces the technology to take this “second screen” engagement to another level. The original patent described the technology to aggregate user comments on a website so that they could be accessed by others in a central location and be made available at a later time. The various embodiments disclosed herein are a continuation of that original patent in that they focus on the application to television. The current disclosure highlights the use of social commenting for interacting with the full range of television programming: sports, entertainment, news, political events, commercial messages, games and entertainment.

By allowing comments to be aggregated on a separate website, the various embodiments increase the visibility and value of the comments. These visible comments act like testimonials both for the television programming and for the brands which advertise on that programming. In this way they create additional value and make the creation of new programming possible. They also increase the value to a viewer of engaging with shows in real time. This makes people less likely to time-shift by recording and more likely to watch commercial messages.

Embodiments presented enable television and cinema viewers to post comments pertaining to television content (e.g. television programs, streaming movies, advertisement, etc.) using mobile apps on their electronic computing device, or on a smart television with a web browser, or a television with internet connectivity. The comments are electronically transmitted via the Internet for storage on remote databases, and/or for display on third party websites, such as social networking websites (e.g. Facebook®, Twitter®, etc.).

This disclosure therefore comprises a computerized method, system, and computer program product installed on, or accessible by, a user electronic computing device to display an application for commenting on television content. In one non-limiting embodiment, the application (e.g. a mobile app or ITV app) may comprise a viewer interface element with one or more screens, or elements in a screen, that: 1) allows the viewer to select or input the identification of the television content—e.g. program, streaming movie, etc.; 2) receives viewer comment data input; 3) transmits over the Internet the comment in response to a user input, such as one user action (e.g. 1-Click) on the application; 3) receives at a remote second website server the viewer input; and, 4) stores the viewer input (i.e. comment(s)) in a database of the second server, and/or displays the comment(s) on a webpage of the website of the second server, and/or transmits the comment to other end-users of the application for viewing on their devices.

The second server, website and webpages, and application may be controlled by a third party, such as a social networking site, that consolidates, edits (e.g. removing viewer identifying information, or taking parts of comments—phrases), and posts the comments of a plurality of viewers. And/or the third party may be an entity that stores the comments on the second server for internal use, such as media rating firm conducting mathematical computations to analyze various factors on the likeability of a television program or advertisement or streaming video or cinema movie.

Additionally, the various embodiments as disclosed herein, as well as variations thereof, may further comprise the comment being transmitted from the second server to a third, fourth, etc. server for storage and/or display on a third, fourth, etc. users' electronic computing devices comprising a commenting app. For example, the second server may comprise a rating firm that screens the database for positive comments, and then transmits them directly, or to a third server, for distribution and display on a plurality of viewer's electronic computing devices, and/or on a website (e.g. a social media—Facebook®).

“Television content” may comprise any program or advertisement (channel of a network, syndicated, cable etc. entity) as viewed on a standard television (i.e. without Internet connectivity). It may also comprise any media content viewed on a smart television with a web browser or a television with Internet connectivity, such as a streaming video or movie (e.g. Netflix®, Hulu®, Amazon®, etc. provider).

Comments may pertain to, for example, televised sports events, votes on game show actions, choices of storyline, votes about a show's characters, news items, testimonials about advertised products, and so forth.

The viewer's electronic computing device may comprise any type of electronic computing device enabled to communicate with the first website server via software installed thereon or accessible via the Internet, such as a mobile app or ITV app. Non-limiting examples of devices comprise: laptop computers, desktop computers, tablet computers, and mobile electronic communications devices—e.g. smartphones, cellular phones, and personal digital assistant devices with web browsers, and smart televisions and televisions with Internet connectivity with software applications for receiving viewer input (ITV app) from another electronic communications device (e.g. remoter control with keyboard).

Additionally, the various embodiments as disclosed herein, as well as variations thereof, the user's input may comprise audio, video, photo, and textual comment data pertaining to television content.

The various embodiments may further comprise a local or remote server with a database (e.g. a website administrator's server) in lieu of, or in addition to, a remote third party second website server for storage of the user's comment.

The present embodiments may further be computer program products installed on electronic computing devices, including smart televisions and televisions with Internet connectivity, for one or more embodiments disclosed herein, wherein the products comprise computer code stored in memory on the system server, such as a remote cloud-based server, and/or accessible by or stored in whole or in part the within the memory of an end user's electronic computing device. The products may further comprise non-transitory computer readable medium containing computer executable instructions to carry out, by the processor, the methods when the instructions are run on an end user's electronic computing device or on a network, and wherein the instructions are downloadable from or stored on a system server. In one embodiment, for example, the computer program product is a mobile application on an end user's computing device (e.g. smartphone) or application on a smart television, wherein the product comprises non-transitory computer readable storage medium containing software instructions that, when executed by the device's processor, cause the device to perform acts included in one or more of the embodiments disclosed herein.

The present disclosure further comprises a non-transitory computer readable apparatus (e.g. server) having at least one computer program or module or application thereon, and configured to execute the methods disclosed herein.

### BRIEF DESCRIPTION OF THE DRAWINGS

For a more complete understanding of the various embodiments, features and aspects of the embodiments, and the advantages thereof, reference is now made to the following descriptions taken in conjunction with the accompanying drawings and flowcharts in which:

FIG. 1A is an illustration of a remote control comprising a keyboard in communication with a smart television or television with Internet connectivity comprising an application installed thereon for commenting on content.

FIG. 1B is an illustration of a smartphone with a mobile app installed thereon for commenting on content viewed on a traditional or on a smart television or television with Internet connectivity or cinema movie.

FIG. 2 is a block diagram of a system according to one or more embodiments herein, including the end-user's and/or web administrator's computing device.

FIG. 3 is a flowchart illustrating the viewer's steps in using an application to distribute comments to other viewers using the same or similar application, and/or to post comments on remote third party websites.

FIG. 5 is a flowchart illustrating the computer steps of an administrator's website providing a television viewer's comments to a remote second server.

FIG. 6 is a flowchart illustrating the computer steps of the remote second website server receiving and storing data from a first website server upon the viewer actuating a submit function.

### DETAILED DESCRIPTION

As used herein, the term “Software” and “Application” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the various embodiments comprise any software components, programs, applications, computer programs, application programs, system programs, machine programs, and operating system software. It is noted that the software application of the various embodiments disclosed herein may be installed on or accessible by the user's mobile device (e.g. smartphone), on a smart television, on a television with Internet connectivity, on a remote control with WIFI or internet connectivity, through a cable box or set top box with WIFI or internet connectivity, a special fob or controller, as well as other similar devices.

As used herein, the term “User Interface Element” refers to a screen displayed by an application as viewed on an electronic computing device (e.g. the interface of a smartphone or smart television screen or screen of a television with Internet connectivity etc.). It may also refer to a part of a screen, such as a tab, check box, drop down menu, text input area, etc.

As used herein, the term “End-user” may refer to viewers of the television content who input and transmit comments, readers of the comments, and/or responders who input comments in response to a viewer's comment. The end-user may also be required to meet pre-set criteria in order to participate in inputting, and/or viewing comments. Criteria may comprise, by way of non-limiting examples, one or more of: being located at a designated venue; and/or, possessing a demographic trait comprising age, race, geographical location, and income.

As used herein, the term “Comment Actuator” refers to a distinguishing feature, marker, or other indicia, as well as or alternatively, a hidden or subtle feature that is activated or may become more pronounced on a touch event by an end-user utilizing the mobile app disclosed herein or as displayed on a webpage of a first website server, or second sub-system as viewed from the end-user computing device. When activated, a module or function can be initiated or a command can be sent to cause such initiation. The comment actuator is typically associated with a portion of the mobile application display or webpage content, such as an image, video and/or audio content included within the webpage or mobile application. It should be appreciated that throughout this description, the term comment actuator can be applied to the modification to a mobile application display and/or associated webpage that allows the viewer of the app/webpage to invoke a commenting function as well as the underlying routine, module or function that results from the actuation.

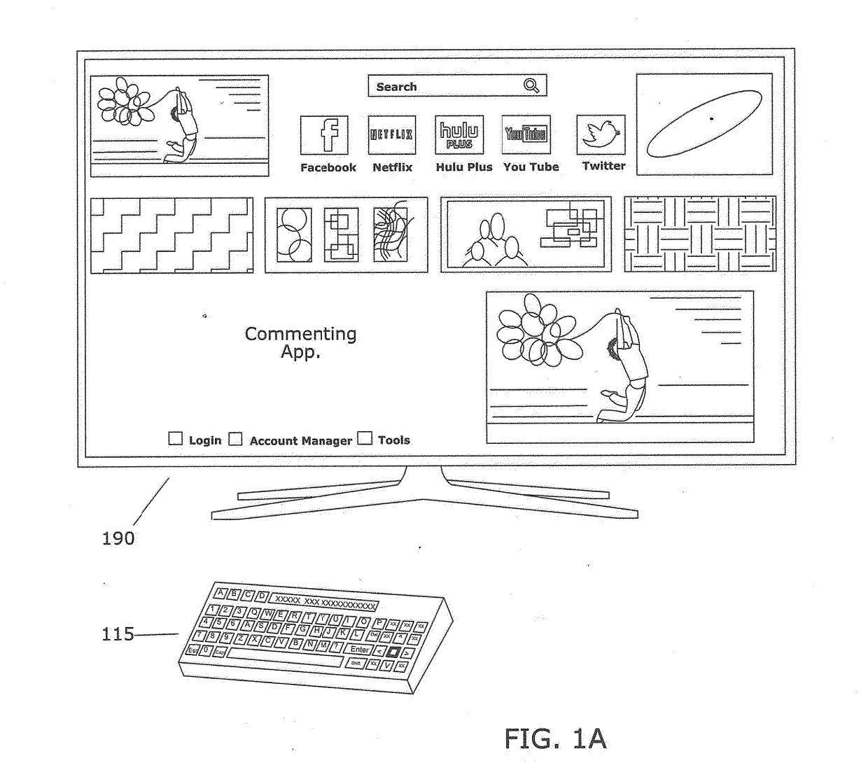

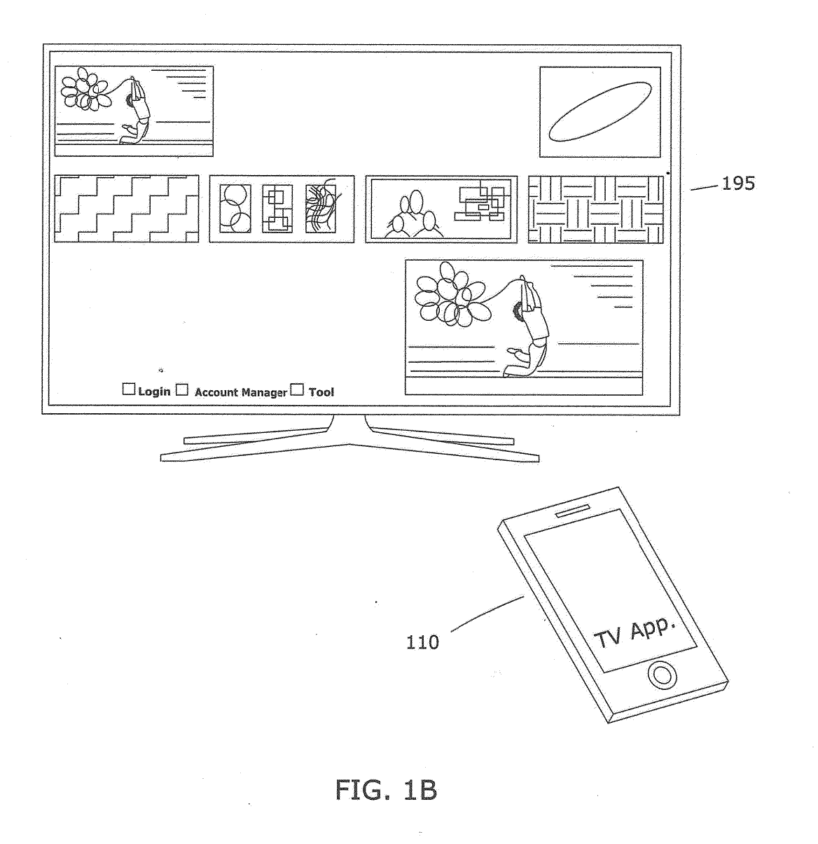

FIG. 1A is an illustration of one embodiment comprising device 190—a smart television with a web browser or a television with Internet connectivity and an application (ITV app) installed thereon that displays interface elements on the television screen to receive viewer's input from the keyboard 115. One interface element (not shown) allows the viewer to input the identity of the television content that they wish to comment on. The interface may comprise a variety of means of allowing the viewer to input their selection, such a drop down menu, and/or to type in the title on the keyboard.

FIG. 1B is an illustration of another embodiment comprising a standard television with or without Internet connectivity, or a movie theater (cinema) screen, 195 as viewed by a user with an electronic computing device 110 comprising a commenting mobile app and Internet connectivity. The viewer is able to enter the identity of the media, and then enter their comments on the user interface elements that are displayed on the screen of their device. In some embodiments, the user device may automatically detect or assist in the detection of the identification of the media. In such embodiments this can be accomplished in a variety of manners, such as by the device receiving a signal from the source of the media content or otherwise, the device scanning the content and performing signal processing and/or analysis to identify the media content (this can be done optically and/or using audio such as SOUNDHOUND technology, the device identifying the current location, date and time and identifying the media content based on this information (such as Theater 1 of University 16 in Athens Ga., on Nov. 20, 2014 at 5:45 PM) etc. They may then electronically transmit via the Internet (either directly or through another connection such as WIFI, RF, etc) their comments to a remote second website server for storage and/or posting on a website and/or distribution to other viewers with similar functioning commenting applications on electronic computing devices 110, 120.

The distribution, or sharing, of the comments may also be limited by geography, event (concert), or venue-such as all the viewers within a movie theater or sports bar. Methods of limiting distribution of comments viewed on mobile apps are well known by the skilled artisan, such as via GPS coordinates, or authentication credentials.

### System Architecture

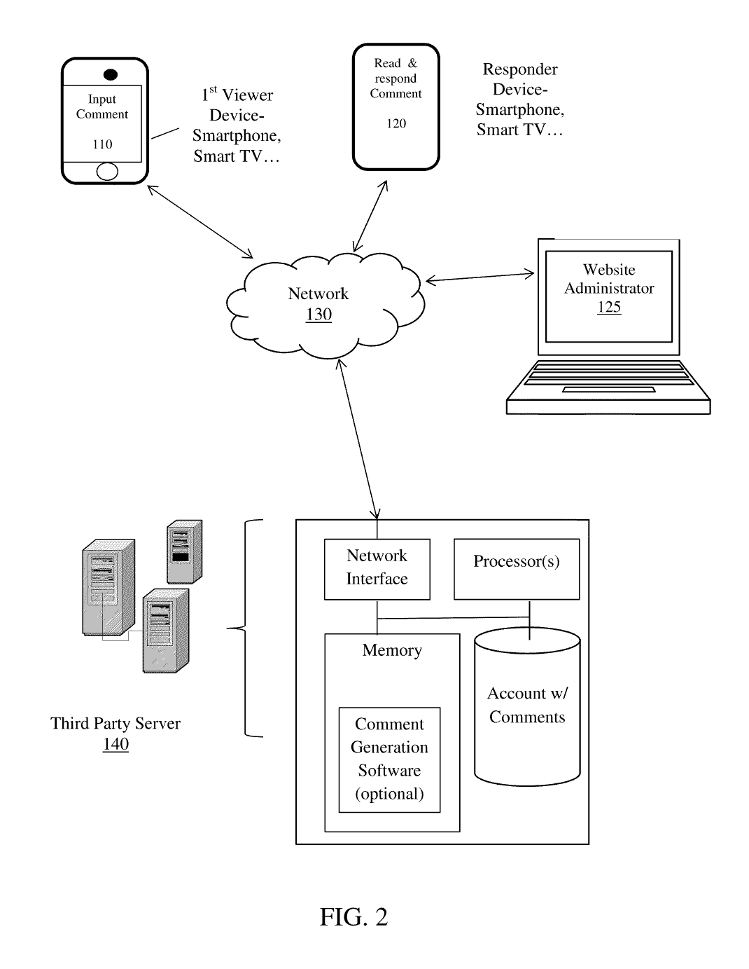

FIG. 2 is a block diagram representing one or more embodiments of the system comprising one or more viewer's computing devices 110 for inputting comments in communication with a plurality of other viewer's computing devices 120 for reading and responding to the first viewer's comments. The system further comprises a first remote website server/device 125 (e.g. media rating firm or website administrator) via a network—Internet 130. The first website server/device 125 may be in further communication via the network 130 with a remote second website server 140 (e.g. social networking server), and/or the devices 110, 120 may be in direct communication with server 140.

Viewer's computing device 110 (and optionally the smart television with web browser or television with internet connectivity device 190 receiving input from a user via a remote control keyboard 115) may comprise any type of electronic computing device enabled to communicate via the network 130 with the first website server 120, using software installed on the device (e.g. a native app) or accessible over the Internet, such as a mobile cloud app and/or a web based app. Non-limiting examples of devices 110 comprise: portable computers, laptop computers, desktop computers, tablet computers, and mobile electronic communications devices—e.g. smartphones, cellular phones, and personal digital assistant devices.

The system further comprises a first website server 125 with the ability to display webpages modified to display comments sent from viewer's devices 110 and reader's devices 120, and to transmit the data to a remote second website server 140 (i.e. a third party's server) for storage in a database. Thus, the website of the first server 125 may display a running dialogue of a plurality of users (110, 120) of the application about a particular television content in real-time (e.g. Academy Awards). The server 125 may comprise all or part of the hardware and software necessary for communicating via the network 130 to end user's device 110, 120, and the remote server 140.

Network 130 is a computer network that relays, at a minimum, data between first viewer's devices 110 and a plurality of other viewers' (readers and responders) devices 120, and the first website server 125, who may also relay the raw data and analyzed data via the network to the remote second website server 140. Network 130 may also include the Internet and/or other types of data networks, such as a local area network (LAN), a wide area network (WAN), a cellular network, and a satellite network: (e.g. Ethernet, 802.11, worldwide interoperability for microwave access (WiMAX), 3G, 4G, CDMA, digital subscriber line (DSL), etc.). The data can be formatted in, for example, JavaScript, Asynchronous JavaScript, hypertext markup language (HTML), Cascading Style Sheets (CSS), and/or the extensible markup language (XML). In one embodiment, iFrame (Inline Frame) is utilized to create an HTML document embedded inside another HTML document on a webpage of the first or second website server 125, 140.

The remote second (third party) website server 140 comprises one or more processors and memory to execute applications to provide cloud-based or local computing services to first website servers 125 via network 130. The server 140 may further comprise a database for storing data (e.g. comments from multiple end-uses, and/or responses to the comments) transmitted from viewer's devices 110, 120 and intermediaries 125 (e.g. rating firm) via the Internet. The database may store the transmissions within account records on server 140.

In one non-limiting example, the server 140 may comprise records for each first viewer's account on a social media website that will consolidate and store all of the viewer's comments pertaining to any media content that they have commented on via their mobile app.

In another non-limiting example, the server 140 may comprise records for a plurality of motion picture or television programs owned by one or more media organizations. The comments may then be filtered using software installed on the server 140, and subsequently posted on designated websites and/or electronically distributed to advertising entities.

### End Users' Computing Devices

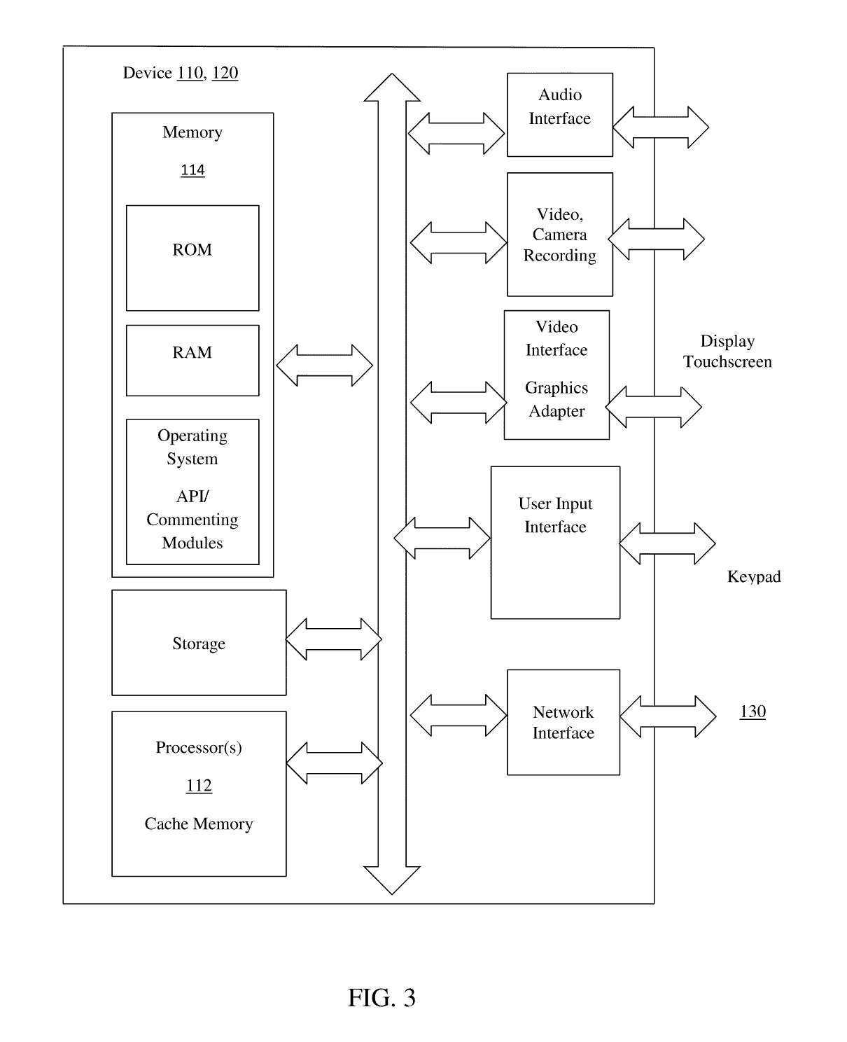

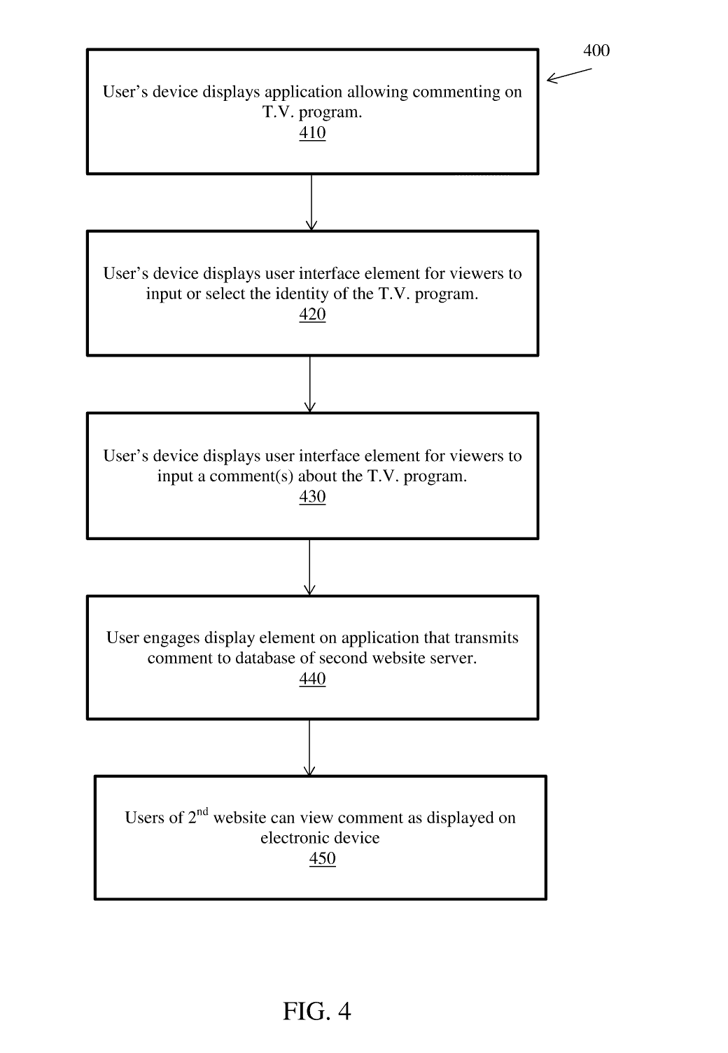

As illustrated in FIG. 3, device(s) 110 and/or 120 in addition to wireless or wired Internet communication capacity, may comprise textual (via email, SMS, IM, online website input, etc.), audio (microphone, speaker, etc.), video and camera image (recording and viewing) of their comments. The viewer's input may thus comprise audio, video, photo, and textual comment data pertaining to television content.

For example, the devices may comprise a smartphone with a touchscreen or a laptop with a keyboard or a tablet with a virtual keypad, wherein all would also comprise Internet connectivity and mobile apps displaying screens for the user to input comments that are sent, received and stored within the device's memory, and/or transmitted electronically for storage on one or more third party's database. The data stored on the third party databases may be displayed on third party websites, such a social networking websites (e.g. Facebook®, Twitter®, etc.), to include more than one third party websites simultaneously. The data may also be stored on the third party database for internal use (e.g. statistical analysis).

The devices further include a processing circuit comprising a processor 112, and a memory 114 storing the commenting application, that stores machine instructions that when executed by the processor 112, cause the processor 112 to perform one or more of the operations and methods described herein. Processor 112 may optionally contain a cache memory unit for temporary local storage of instructions, data, or computer addresses. For example, using instructions retrieved from memory 114, the processor 112 may control the reception and manipulation of input and output data between components of the device 110. In various embodiments, the processor 112 can be implemented as a single-chip, multiple chips and/or other electrical components including one or more integrated circuits and printed circuit boards.

The processor 112 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 114 encompasses one or more storage mediums and generally provides a place to store computer code (e.g., software and/or firmware) and data that are used by the device 110 (and optionally 120). It may comprise, for example, electronic, optical, magnetic, or any other storage or transmission device capable of providing the processor 112 with program instructions. Memory 114 may further include a floppy disk, CD-ROM, DVD, magnetic disk, memory chip, ASIC, FPGA, EEPROM, EPROM, flash memory, optical media, or any other suitable memory from which processor 112 can read instruction, in computer programming languages.

Memory 114 may include various other tangible, non-transitory computer-readable media including Read-Only Memory (ROM) and/or Random-Access Memory (RAM). As is well known in the art, ROM acts to transfer data and instructions uni-directionally to the processor 112, and RAM is used typically to transfer data and instructions in a bi-directional manner

Processor 112 is generally coupled to a variety of interfaces such as graphics control (e.g. graphical processing unit (GPU)), video interface, audio interface, input interface (e.g. touchscreen data input and/or keypad), and other interfaces, such as camera hardware and software components housed within and/or connected to device 110 for recording and transmitting, via network 130, digital photos, audio and video events.

Processor 112 is also coupled to a network interface that allows the processor to be coupled to another computer or telecommunications network (e.g., network 130). More particularly, the network interface generally allows processor 112 to receive information from and to output information to the network 130 in the course of performing various method steps described in the embodiments herein.

The computing devices 110, 120 may further have installed within the device's memory a module comprising a native application, a web application, or a widget type application to carry out the methods of the embodiments disclosed herein. In a preferred embodiment, a native application (e.g. computer program product) is installed on the device, wherein it is either pre-installed on the device or it is downloaded from the Internet via email and activated with a code generated by the system server. It may be written in a language to run on a variety of different types of devices; or it may be written in a device-specific computer programming language for a specific type of device.

In another embodiment, a web application resides on the first website server 125, or second website server 140, and is accessed via the network 130. It performs basically all the same task as a native application, usually by downloading part of the application to the end user's device 110, 120 for local processing each time it is used. The web application software is written as Web pages in HTML and CSS or other language serving the same purpose, with the interactive parts in JavaScript or other language. Or the web application can comprise a widget as a packaged/downloadable/installable web application; making it more like a traditional application than a web application; but like a web application uses HTML/CSS/JavaScript and access to the Internet. And/or devices 110, 120 may include a web browser running applications (e.g. Java applets or other like applications), comprising application programming interfaces (“APIs”) to other software applications running on remote servers that provide, for example, cloud based services and comment posting.

### Various T.V. Commenting Methods

The applications of the various embodiments provide at least the following functionality, and may comprise further features: 1) allows the viewer to select or input the identification of the television content—e.g. program or streaming movie or advertisement from a user interface element (screen); 2) allows the viewer to input their comment(s) about the television content into a user interface element displayed by the app; 3) transmits over the Internet the comment in response to a user input, such as one user action (e.g. 1-Click) on a user interface element displayed by the application; 4) receives at a remote second website server the user input comprising the comment; and, 5) stores the user input (i.e. comment(s)) in a database of the second server (FIG. 2, 140), and/or displays it on a webpage of the website of the second server, and/or displays it on an application that is read by a plurality of users of the application using their electronic computing device (FIG. 2, 120).

The applications may further provide functionality for the plurality of users (readers) utilizing their electronic computing devices 120 to input and transmit comments to respond to the first viewer's comments, and thus create an online dialogue in real-time. The users' responsive comments may be transmitted to the first server 125, the second server 140, or directly to the viewer's device 110.

Referring to Table 1, FIG. 4, a flowchart 400 is provided illustrating the steps for a viewer with an electronic computing device with Internet connectivity to input and send comments on their television and/or cinema viewing to remote third party servers. The viewer's device may comprise a mobile application, such as a smartphone with a mobile commenting app, or an electronic device (e.g. remote control) in communication with a smart television comprising ITV commenting applications. Whether the application is installed on the viewer's device or television, it has all of the functionalities required for television commenting as disclosed in FIGS. 4-6.

TABLE 1

| Step | Action |
|---|---|
| 410 | A first end-user's electronic computing device, that is in communication with a |
| | first and/or second server via the internet (e.g. a cellphone, laptop, tablet, |
| | portable computer, or other computational device), displays a mobile application |
| | permitting the end-user to comment on a television and/or cinema content. |
| 420 | The mobile app/webpage displays a user interface element that allows the end- |
| | user to select or input the television or cinema identification data. |
| 430 | The mobile app/webpage provides a user interface element allowing the end-user |
| | to make a comment about the content. |
| 440 | The end-user engages a display element on the webpage that causes the comment |
| | to be sent to a database on the first or second server. |
| 450 | A plurality of end-users of the second server-website may view and respond to |
| | the first end-user's comments. |

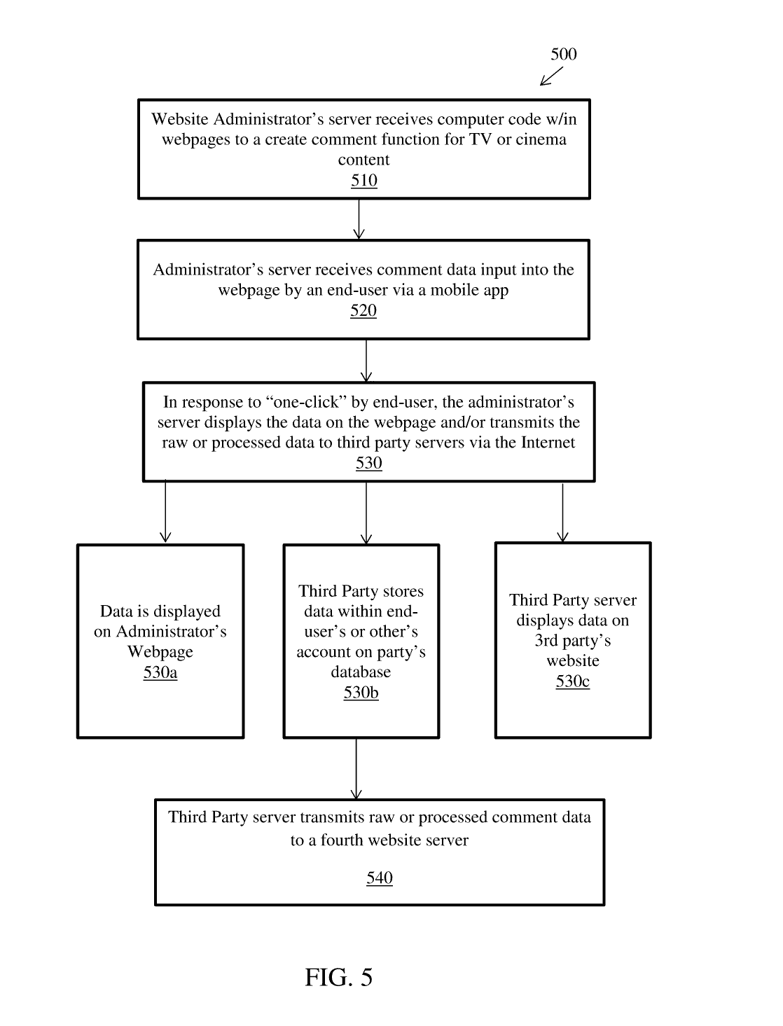

Referring to FIG. 5 and Table 2, a flowchart 500 is provided for illustrating another embodiment or aspect, comprising the first website server 125 receiving comments from devices 110 and 120, and displaying them on one or more webpages of the website of 125. The server 125 may concurrently, or subsequently, transmit the original comments, and/or edit or otherwise process the comments (e.g. statistical analysis), and then transmit them via the Internet 130 to the second website server (FIG. 2, 140). The second server 140 may subsequently post the comments on the website of the server 140, and/or further edit or process the comments, and/or distribute them to other entities (e.g. fourth server of a movie reviewer).

TABLE 2

| Step | Action |
|---|---|
| 510 | Website Administrator's first server receives computer code w/in |
| | webpages to receive comment functions transmitted by viewers of |
| | television content from their electronic devices. |
| 520 | Administrator's server receives data (e.g. a comment) input into |
| | the webpage by a television and/or cinema viewer. |
| 530 | In response to “one-click” or input by the viewer, the |
| | administrator's server displays the data on the webpage and/or |
| | transmits the data to third party servers via the network. |
| 530a | Data (comment) is displayed on Administrator's Webpage. |
| 530b | Third Party stores data (comment) within viewer's account on |
| | Third Party's database. |
| 530c | Third Party server displays data (comment) on Third Party's |
| | website. |
| 540 | Third Party server transmits raw or processed data (comment) to |
| | fourth party's server via the network. |

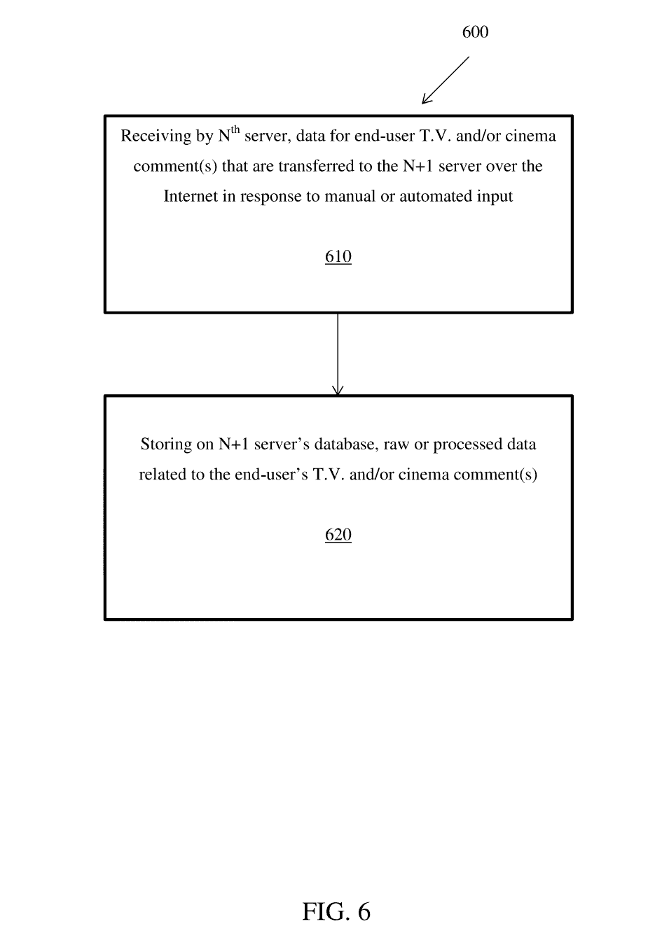

Referring to FIG. 6 and Table 3, a flowchart 600 is provided for illustrating the steps taken by the N^{th} party's website server (i.e. second, third, etc. website server) in receiving and storing the viewer's raw or processed comment. The N^{th} party may be, for example, a television rating firm that will utilize the comments stored in the database to perform mathematical computations to “rate” the favorability of a particular television program or streaming movie, and specific aspects of it (e.g. likeability of characters, plot, etc.). The ratings firm then electronically transmits the processed data, and associated statistics, to an N+1 server, for storage, display, and further distribution. Non-limiting examples of an N+1 server and website comprise the television company that aired the content, a television marketing organization that utilizes the processed data to create favorable advertising for the show, and so forth. The N+1 server may subsequently transmit the processed data and other information to yet an N+2 server, such as an advertising distributor responsible for airing a commercial, and displaying advertising on the Internet, to promote the television show.

TABLE 3

| Step | Action |
|---|---|
| 610 | Receiving by a remote N^{th} server, raw or processed data for a |
| | viewer's or responder's comment that is subsequently transmitted |
| | to a N + 1 server upon activation of the submit function of the |
| | mobile app on the viewer's computing device. |
| 620 | Storing on N + 1 server's database, raw or processed data related |
| | to the comment. |

In one aspect, the server may be the first server 125 or the second server 140 that receives the viewer's comment or responder's comment that is transferred to an N+1 server upon activation of a submit function on application of viewer's device 110 or responder's device 120. The submit function may be a user interface element comprising one user action, such as a 1-Click input tab.

And/or the N^{th} server may receive the viewer's and responder's raw data comments or processed comments from another server upon activation of a submit function from a user interface element on a webpage, an application, or programmed into the processing of the data comments (e.g. programmed for automatic transmission by processor).

A number of implementations, embodiments, and aspects have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. In a system comprising one or more end-user computing devices, and a first website server communicatively coupled to a mobile application running on the end-user computing device and to a second website server, a method comprising:
a. receiving on an end-user device, comment data input, wherein the comment pertains to media content viewed by the end-user;
b. in response to an end-user activation displayed by the mobile application, displaying the comment on a webpage of the first website server and transmitting the comment data over the Internet to a second website server;
c. displaying the comment on a website of a second website server, and storing the comment on a database of the second website server, wherein the database comprise records for a plurality of end-users; and,
d. wherein an end-user comprises a viewer of the media content, and a responder who inputs comments in response to a viewer's comment.

2. The system of claim 1, wherein the media content comprises television programs, streaming movies, streaming videos, cinema movies, television advertisements, and cinema advertisements.

3. The system of claim 1, wherein a plurality of end-user comment data is processed and statistical data generated by the first and/or second server.

4. The system of claim 1, wherein the media content is being viewed in real-time.

5. The system of claim 1, wherein the end-user's computing device may comprise one of a group of devices including a smartphone, laptop, desktop, tablet computer, a smart television with a remote control; and a television with internet connectivity with a remote control.

6. The system of claim 1, wherein the second server database further comprises records for each of an end-user's social media accounts located on a plurality of first server websites, the records comprising a history of end-user's comments on content.

7. The content commenting system of claim 1, wherein the third sub-system comprises a database storing records for end-user comments on a plurality of cinema or television programs owned by one or more media organizations.

8. The content commenting system of claim 7, wherein the third sub-system further comprises a means to filter the end-user comments, and transmit the filtered comments to a fourth sub-system comprising one or more advertising entities.

9. The system of claim 1, wherein the end-user's comment data input comprises audio, video, photo, and textual comment data pertaining to the television content and cinema content.

10. A content commenting system for media content viewing comprising:
a. a first sub-system configured to present media content that can be perceived by an end-user with a computing device;
b. a comment actuator associated with at least a portion of the media content, and displayed on the end-user computing device interface;
c. a second sub-system configured to: receive comment data in response to the comment actuator being actuated, the comment data including information to identify the associated media content and, comment information pertaining to the media content; and,
d. provide the comment data to a third sub-system.

11. The content commenting system of claim 10, wherein the comment data is received in response to the end user providing any one of or a combination of text, audio, video and graphic input.

12. The content commenting system of claim 10, wherein the end-user device of the first sub-system comprises one or more of a smart television with a web browser and a remote control; a television with Internet connectivity with a remote control; a computer with streaming video content; a smartphone used while viewing a standard television and/or a cinema theater.

13. The content commenting system of claim 10, wherein the second sub-system or the third sub-system generates statistical data on comment data from a plurality of end-user computing devices.

14. The content commenting system of claim 10, wherein the third sub-system comprises a database storing records for each of an end-user's social media accounts located on a plurality of second sub-systems, the records comprising a history of the end-user's comments on content.

15. The content commenting system of claim 10, wherein the third sub-system comprises a database storing records for end-user comments on a plurality of cinema or television programs owned by one or more media organizations.

16. The content commenting system of claim 15, wherein the third sub-system further comprises a means to filter the end-user comments, and transmit the filtered comments to a fourth sub-system comprising one or more advertising entities.

17. A non-transitory computer-readable storage medium storing instructions that, when executed by a processor, cause a computer system to transmit and store media comments on a remote server for viewing and responding to by third parties, by performing the steps of:
a. receiving on an end-user device interface, comment data input, wherein the comment pertains to television and/or cinema content viewed or responded to in real-time by an end-user;
b. in response to an end-user activation displayed on an end-user device interface, displaying the comment on a webpage of the first website server and transmitting the comment data over the Internet to a second website server;
c. displaying the comment on a website of a second website server, and/or storing the comment on a database of the second website server, wherein the database comprises records for a plurality of end-users; and,
d. wherein an end-user comprises a viewer of the television or cinema content, and a responder who inputs comments in response to a viewer's comment.

18. The non-transitory computer-readable storage medium of claim 18, wherein the content comprises television programs, streaming movies, streaming videos, cinema movies, television advertisements, and cinema advertisements.

19. The non-transitory computer-readable storage medium of claim 18, wherein a plurality of end-user comment data is processed and statistical data generated by the first and/or second server.

20. The non-transitory computer-readable storage medium of claim 18, wherein the end-user's computing device comprises a smartphone; laptop, desktop, tablet computer; and/or a smart television with a web browser and a remote control; a television with internet connectivity and a remote control.
